(19) United States
(12) Patent Application Publication
(10) Pub. No.: US 2006/0152043 A1
(43) Pub. Date: Jul. 13, 2006

(54) Plastics material elongate member forming part of a roof structure, a roof structure member, a roof arch, a roof frame, and a roof module for a motor vehicle

(76) Inventor: Eric Bonneau, Saint Romain De Jalionas (FR)

Correspondence Address: EPSTEIN DRANGEL BAZERMAN & JAMES, LLP, 60 EAST 42ND STREET, SUITE 820, NEW YORK, NY, 10165, US

(21) Appl. No.: 11/261,311

(22) Filed: Oct. 28, 2005

(30) Foreign Application Priority Data
Oct. 28, 2004 (FR) 0411529

(51) Int. Cl. B62D 25/06

(52) U.S. Cl. 296/210

(57) ABSTRACT

The plastics material elongate member is designed to co-operate with a sheet-metal elongate hollow body by being bonded thereto in such a manner as to impart rigidity to the roof structure. The elongate member is shaped in such a manner as to be fitted against the hollow body and to be bonded to a seat of the hollow body so as to co-operate with the hollow body to constitute the roof structure. The structure member includes a sheet-metal elongate hollow body contributing to the stiffness of the structure member. It further includes a plastics material elongate member as defined above. The sheet-metal hollow body and the elongate member are bonded together in such a manner as to form a structure imparting rigidity to the structure member. The roof arch and the roof frame of the invention include such a structure member.

The present invention relates to an elongate member of plastics material forming part of a roof structure, to a roof structure member, to a roof arch, to a roof frame, and to a roof module for a motor vehicle.

### BACKGROUND OF THE INVENTION

In the state of the art, and in particular from DE 32 04 526, there is already known a plastics material elongate member forming part of a motor vehicle roof structure, that is designed to co-operate with a sheet-metal elongate hollow body by being bonded thereto in such a manner as to impart rigidity to the roof structure.

That plastics material member is overmolded on the sheet-metal hollow body so as to form the rigid roof structure.

A roof structure obtained in that way is advantageous since its weight is relatively reduced compared with the weight of conventional roof structures designed to be made solely out of sheet metal.

Nevertheless, the design of such a roof structure is very different from the design of a conventional roof structure made of sheet metal, and adopting such a design makes it necessary to implement major modifications in conventional motor vehicle assembly lines, leading to considerable expense.

In the state of the art, a motor vehicle roof structure member is also already known that includes a sheet-metal elongate hollow body contributing to the stiffness of the structure member.

In general, that conventional structure member of sheet metal forms a motor vehicle roof arch.

It should be observed that a motor vehicle assembled in a conventional assembly line commonly includes such a structure member.

Usually, the motor vehicle roof extends between two roof arches, each extending in the longitudinal direction of the motor vehicle. Each roof arch contributes to the stiffness of the motor vehicle body. Indeed, the sheet-metal hollow body forms a box beam stiffening the arch and the elements connected to the arch.

In general, various pieces of equipment are arranged in the top portion of the motor vehicle, in particular for driving a window arranged in the vehicle roof. Under such circumstances, these pieces of equipment include a motor for actuating the window.

Unfortunately, a roof arch generally comprises only a structural portion that is unsuitable for receiving pieces of equipment.

It is therefore necessary to arrange means for carrying the pieces of equipment in the space defined by the two roof arches. Such means comprise, for example, a frame made of plastics material.

Since these means for carrying pieces of equipment are generally bulky, the opening available for the motor vehicle roof window is reduced.

### OBJECTS AND SUMMARY OF THE INVENTION

A particular object of the present invention is to remedy that drawback by providing a roof structure member, e.g. forming a motor vehicle roof arch, that makes it possible in particular to arrange pieces of equipment in the top portion of the motor vehicle without having recourse to means that are too bulky.

Another object of the invention is to reduce the weight of the roof structure, but without requiring major modifications to conventional motor vehicle assembly lines.

To this end, the invention provides a plastics material elongate member forming part of a motor vehicle roof structure, that is designed to co-operate with a sheet-metal elongate hollow body by being bonded thereto in such a manner as to impart rigidity to the roof structure, the member being shaped in such a manner as to be fitted against the hollow body and to be secured to a seat of the hollow body in such a manner as to co-operate with the hollow body to constitute the roof structure.

The stiffness of the roof structure is provided by the hollow body (forming a box beam) and the plastics material elongate member bonded to the hollow body in accordance with the invention. As a result, the transverse size of the hollow body can be reduced so as to release space for the plastics material elongate member, and this can be done without reducing the stiffness of the structure member since the plastics material elongate member contributes to said stiffness.

Thus, the roof structure member of the invention presents stiffness that is very satisfactory, while reducing its weight and allowing various pieces of equipment to be arranged in the plastics material portion (elongate member) of said structure member.

Indeed, it is easy to manufacture an elongate member out of plastics material with a shape that is relatively complex and adapted to integrating additional functions in the structure member, such as the function of supporting various pieces of equipment, the function of absorbing energy in the event of the vehicle body being accidentally deformed, the function of passing electric cables, the function of conveying conditioned air, etc.

Since these additional functions are provided directly by the structure member (generally a roof arch), there is no longer any need to add additional means that would reduce the space between two structure members (generally two roof arches) mounted on the motor vehicle.

It should be observed that such a plastics material elongate member can be assembled to the sheet-metal body on a conventional assembly line, since the only additional operation required is that of assembling the plastics material elongate member to the sheet-metal body.

A plastics material elongate body of the invention may also include one or more of the following features:
the plastics material elongate member is of generally hollow shape;
the plastics material elongate member presents a U-shaped section
the plastics material elongate member includes energy absorber means designed to absorb energy in the event of the roof structure being deformed in such a manner as to tend to move the roof closer to a motor vehicle cabin;
the plastics material elongate member forms a support for various pieces of equipment;
the plastics material elongate member is shaped to be disposed on the inside of the motor vehicle relative to the sheet-metal hollow body;
the plastics material elongate member is provided with a masking member for providing an attractive appearance to the inside of the motor vehicle;
the plastics material elongate member is shaped to be arranged on the outside of the motor vehicle relative to the sheet-metal hollow body; and
the plastics material elongate member is formed by a portion of a plastics material frame.

The invention also provides a motor vehicle roof structure member of the type comprising a sheet-metal elongate hollow body contributing to the stiffness of the structure member, the structure member including a plastics material elongate member as defined above, the sheet-metal hollow body and the elongate member being bonded together in such a manner as to form a structure imparting rigidity to the structure member.

A structure member of the invention may also include one or more of the following characteristics:
the sheet-metal hollow body is shaped to form a seat against which the plastics material elongate member is secured;
the structure member includes a plastics material elongate member, in which the sheet-metal hollow body is shaped to provide an attractive appearance to the outside of the motor vehicle;
the structure member is designed to carry a motor vehicle roof panel designed to be secured to the sheet-metal hollow body;
the structure member is designed to carry a motor vehicle roof panel designed to be secured to the plastics material elongate member;
the structure member includes a motor vehicle roof panel molded together with the plastics material elongate member; and
the sheet-metal hollow body and the plastics material elongate member are bonded together by adhesive.

The invention also provides a motor vehicle roof arch comprising a roof structure member as defined above extending substantially longitudinally relative to the vehicle and imparting rigidity to the roof arch.

The invention also provides a motor vehicle roof frame of the type comprising two longitudinal sides interconnected by two transverse sides, wherein at least one of the sides is formed by a roof structure member as defined above.

Optionally, each side of the roof frame is formed by a roof structure member.

Preferably, the plastics material elongate members of the four sides are interconnected in such a manner as to form a plastics material frame.

Finally, the invention provides a motor vehicle roof module of the type comprising at least one module element, the module including a plastics material elongate member for being bonded to a sheet-metal elongate hollow body to form a roof structure member, the plastics material elongate member carrying the module element.

Preferably, the module element is a roof panel.

The roof module can thus be mounted on the motor vehicle in a single mounting operation during which the vehicle is fitted on a single occasion with a roof panel, with various pieces of equipment, and with various functions provided by the plastics material elongate member.

In addition, the dimensions of the sheet-metal hollow body can be small so as to leave space for the roof module, and this can be done without reducing the stiffness of the roof structure member since the roof module contributes to said stiffness.

### BRIEF DESCRIPTION OF THE DRAWINGS

The invention can be better understood on reading the following description given purely by way of example and made with reference to the accompanying drawings, in which:

FIG. 1 is a cross-section view of a motor vehicle roof arch in a first embodiment of the invention; and

FIGS. 2 to 6 are views analogous to FIG. 1 showing a roof arch in second to sixth embodiments of the invention.

### MORE DETAILED DESCRIPTION

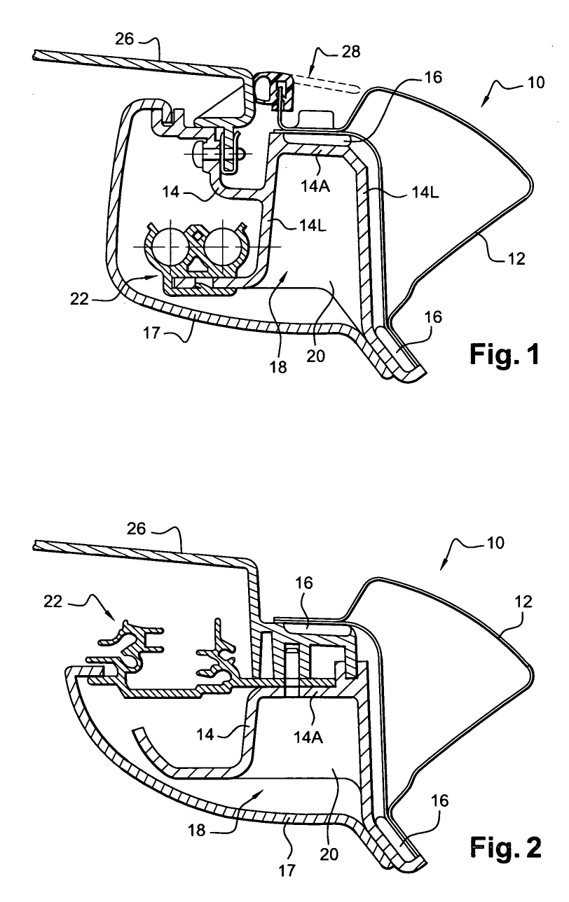

FIG. 1 shows a roof structure member given overall reference 10, in a first embodiment of the invention.

In this embodiment, the structure member 10 forms a motor vehicle roof arch.

The roof arch 10 comprises a hollow body 12 of sheet metal and an elongate member 14 of plastics material. The sheet-metal hollow body 12 and the plastics material elongate member 14 are connected together so as to form a structure imparting rigidity to the arch 10. Preferably, the sheet-metal hollow body 12 and the plastics material elongate member 14 are assembled together by adhesive, with spots of adhesive being given reference 16. In a variant, the sheet-metal hollow body 12 and the plastics material elongate member 14 could be assembled together by using lines of adhesive.

Preferably, the sheet-metal hollow body 12 is shaped to form a seat on which the plastics material elongate member 14 is secured.

The plastics material elongate member 14 is arranged on the inside of the motor vehicle relative to the hollow body 12. Thus, while the roof arch 10 is being mounted, the plastics material elongate member 14 is brought up to it and bonded from beneath with the sheet-metal hollow body 12.

In order to ensure that the plastics material elongate member 14 is not visible from inside the motor vehicle cabin, a masking member 17 is fitted against the elongate member 14. This masking member 17 serves to provide an attractive appearance to the inside of the motor vehicle. In a variant, the plastics material elongate member 14 can be molded in such a manner as to enable it itself to perform the function of being attractive in appearance.

Furthermore, since the hollow body 12 is visible from outside the motor vehicle, it is shaped so as to contribute to the outside appearance of the motor vehicle. The hollow body 12 is generally painted at the same time as the remainder of the vehicle body.

In the first embodiment of the invention, the plastics material elongate member 14 is hollow and presents a U-shaped section defined by two flanges 14L that are substantially vertical and interconnected by a web 14A.

The plastics material elongate member 14 has means 18 for absorbing energy in the event of the arch 10 being deformed in such a manner that tends to move the roof of the motor vehicle towards a cabin of the motor vehicle. Thus, the roof arch 10 integrates a function of protecting the passengers of the motor vehicle in the event of the motor vehicle rolling over.

By way of example, the energy absorber means 18 comprise ribs 20 extending across the inside of the plastics material elongate member 14 between the flanges 14L.

Furthermore, the plastics material elongate member 14 is shaped in such a manner as to define supports or housings for various pieces of equipment 22. In this embodiment, the pieces of equipment 22 are means for securing electric cables.

It should be observed that the plastics material elongate member 14 can carry various other pieces of equipment, for example a motor for opening a window in the roof of the motor vehicle, ducts for air conditioning, etc.

The roof arch 10 is also designed to receive a roof panel 26 constituting a module element that is generally secured on the plastics material elongate member 14 on a lateral extension of one of the flanges 14L of the member 14, e.g. by screw fastening.

For reasons of appearance, provision could also be made for a gasket 28 to be arranged between the roof panel 26 and the hollow body 12.

In general, the roof structure member 10 forming a roof arch is one side of a motor vehicle roof frame.

The roof frame (not shown) preferably has two longitudinal sides formed by roof arches similar to the roof arch 10, interconnected by two transverse sides likewise formed by roof structure members of the invention.

Preferably, the plastics material elongate members 14 constituting the four sides of the roof frame are interconnected so as to form a frame of plastics material. This frame of plastics material is fitted against and stuck to the underside of the hollow bodies 12 forming the four sides of the roof frame.

The plastics material frame includes the pieces of equipment 22 and performs in particular the same functions as the elongate member 14, e.g. the above-described functions of providing attractive appearance and of absorbing impacts.

In addition, a module element, such as the roof panel 26, can be secured to the plastics material frame prior to being mounted on the motor vehicle. This constitutes a roof module suitable for being mounted on the motor vehicle in a single mounting operation, by bringing simultaneously the roof panel 26, the pieces of equipment 22, the function of stiffening the motor vehicle body, and the other functions provided by the plastics material frame.

In FIGS. 2 to 6, elements analogous to those of FIG. 1 are designated by identical references.

In the second embodiment, described with reference to FIG. 2, the hollow body 12 is stuck both onto the elongate member 14 and onto the roof panel 26. The roof panel 26 is secured to the web 14A of the plastics material elongate member 14 by screw fastening. In a variant, the roof panel 26 may be secured to the web 14A by adhesive.

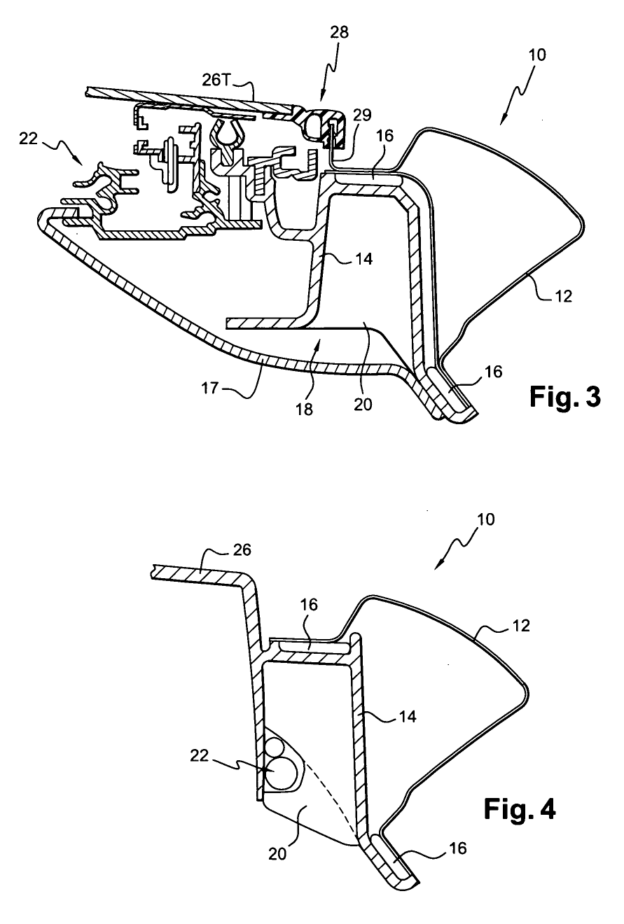

In the third embodiment, described with reference to FIG. 3, the motor vehicle has an opening roof carried in part by the roof arch 10. The roof then has a generally transparent window 26T capable of sliding between roof-open and roof-closed positions.

The pieces of equipment 22 generally include means for guiding the window 26T in sliding, and also a motor for actuating the window 26T.

Furthermore, a gasket 28 is arranged on the sheet-metal hollow body 12, by clamping onto a lip 29 forming part of the hollow body 12. In the roof-closed position, the window 26T comes into co-operation with this gasket 28.

Generally, the gasket 28 is a sealing gasket, and it may be shaped in such a manner as to provide an attractive appearance for the outside of the vehicle.

In the fourth embodiment, described with reference to FIG. 4, the roof panel 26 is of plastics material. The panel 26 is molded together with the plastics material elongate member 14, or is overmolded onto said plastics material elongate member 14. In a variant that is not shown, the panel 26 may be a pre-varnished metal sheet secured to an overmolded plastics material part extending the elongate member 14.

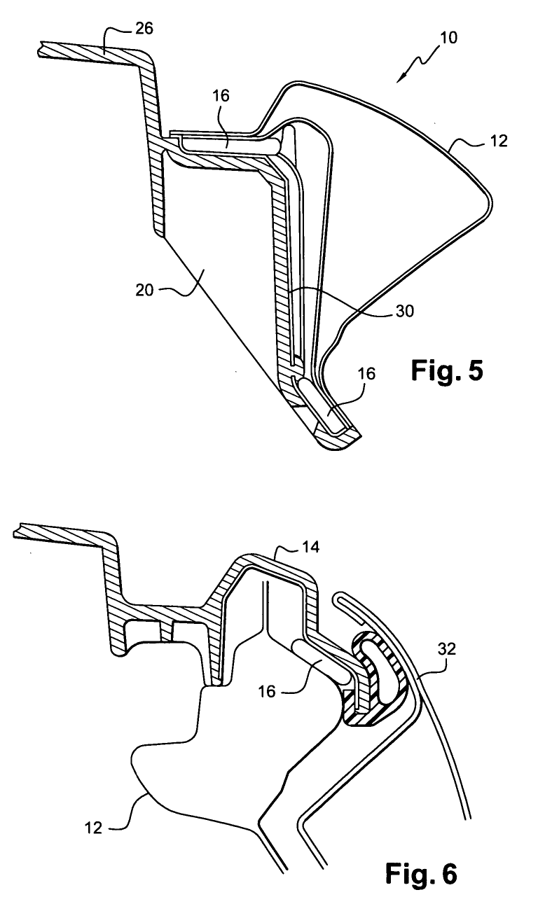

The fifth embodiment, described with reference to FIG. 5, differs from the embodiment of FIG. 4 in that the plastics material elongate member 14 is overmolded on a metal sheet 30. This sheet 30 is stuck to the hollow body 12. In a variant, the sheet 30 could be welded to the hollow body 12.

The sixth embodiment, described with reference to FIG. 6, differs from the above-described embodiments in that the plastics material elongate member 14 is arranged on the outside of the motor vehicle relative to the sheet-metal hollow body 12.

In this configuration, the elongate member 14 is shaped to provide an attractive appearance for the outside of the motor vehicle, in particular in association with pieces of bodywork 32 adjacent to the elongate member 14, e.g. doors for the motor vehicle.

In a variant, a coated sheet-metal element could be arranged on the elongate member 14 to provide the attractive appearance for the outside of the vehicle. This sheet-metal element could be painted at the same time as the remainder of the vehicle body.

It should be observed that the invention is not restricted to the above-described embodiments. Indeed, it is possible to combine the various characteristics of the different embodiments described without going beyond the ambit of the invention.

What is claimed is:

1. A plastics material elongate member forming part of a motor vehicle roof structure, that is designed to co-operate with a sheet-metal elongate hollow body by being bonded thereto in such a manner as to impart rigidity to the roof structure, the member being shaped in such a manner as to be fitted against the hollow body and to be secured to a seat of the hollow body in such a manner as to co-operate with the hollow body to constitute the roof structure.

2. A plastics material elongate member according to claim 1, of generally hollow shape.

3. A plastics material elongate member according to claim 2, presenting a U-shaped section.

4. A plastics material elongate member according to claim 1, including energy absorber means designed to absorb energy in the event of the roof structure being deformed in such a manner as to tend to move the roof closer to a motor vehicle cabin.

5. A plastics material elongate member according to claim 1, forming a support for various pieces of equipment.

6. A plastics material elongate member according to claim 1, shaped to be disposed on the inside of the motor vehicle relative to the sheet-metal hollow body.

7. A plastics material elongate member according to claim 6, provided with a masking member for providing an attractive appearance to the inside of the motor vehicle.

8. A plastics material elongate member according to claim 1, shaped to be arranged on the outside of the motor vehicle relative to the sheet-metal hollow body.

9. A plastics material elongate member according to claim 1, formed by a portion of a plastics material frame.

10. A motor vehicle roof structure member of the type comprising a sheet-metal elongate hollow body contributing to the stiffness of the structure member, the structure member including a plastics material elongate member according to claim 1, the sheet-metal hollow body and the elongate member being bonded together in such a manner as to form a structure imparting rigidity to the structure member.

11. A structure member according to claim 10, wherein the sheet-metal hollow body is shaped to form a seat against which the plastics material elongate member is secured.

12. A structure member according to claim 10, including a plastics material elongate member according to claim 6, in which the sheet-metal hollow body is shaped to provide an attractive appearance to the outside of the motor vehicle.

13. A structure member according to claim 10, for carrying a motor vehicle roof panel designed to be secured to the sheet-metal hollow body.

14. A structure member according to any one of claims 10 to 12, for carrying a motor vehicle roof panel designed to be secured to the plastics material elongate member.

15. A structure member according to any one of claims 10 to 12, comprising a motor vehicle roof panel molded together with the plastics material elongate member.

16. A structure member according to any one of claims 10 to 15, in which the sheet-metal hollow body and the plastics material elongate member are bonded together by adhesive.

17. A motor vehicle roof arch, comprising a roof structure member according to claim 10, extending substantially longitudinally relative to the vehicle and imparting rigidity to the roof arch.

18. A motor vehicle roof frame of the type comprising two longitudinal sides interconnected by two transverse sides, wherein at least one of the sides is formed by a roof structure member according to claim 10.

19. A roof frame according to claim 18, wherein each side is formed by a roof structure member according to claim 10.

20. A roof frame according to claim 19, wherein the plastics material elongate members of the four sides are interconnected in such a manner as to form a plastics material frame.

21. A motor vehicle roof module of the type comprising at least one module element, the module including a plastics material elongate member for being bonded to a sheet-metal elongate hollow body to form a roof structure member, the plastics material elongate member carrying the module element.

22. A roof module according to claim 21, in which the module element is a roof panel.
